(19) United States
(12) Patent Application Publication
(10) Pub. No.: US 2012/0154923 A1
(43) Pub. Date: Jun. 21, 2012

(54) LENS AND METHOD OF MANUFACTURING THE SAME

(75) Inventor: Cheong Hee LEE, Suwon (KR)

(73) Assignee: SAMSUNG ELECTRO-MECHANICS CO., LTD., Suwon (KR)

(21) Appl. No.: 13/323,106

(22) Filed: Dec. 12, 2011

(30) Foreign Application Priority Data
Dec. 15, 2010 (KR) 10-2010-0128309

(51) Int. Cl. G02B 3/00; B32B 37/14; B32B 37/12

(52) U.S. Cl. 359/642; 156/60

(57) ABSTRACT

There are provided a lens and a method of manufacturing the same. The lens includes: a first lens member having a lens surface formed thereon; a second lens member having a lens surface formed thereon; and an adhesive member adhering the first and second lens members to each other, wherein the first and second lens members include a ventilation path formed therebetween in order to discharge air therethrough.

### CROSS-REFERENCE TO RELATED APPLICATIONS

This application claims the priority of Korean Patent Application No. 10-2010-0128309 filed on Dec. 15, 2010, in the Korean Intellectual Property Office, the disclosure of which is incorporated herein by reference.

### BACKGROUND OF THE INVENTION

1. Field of the Invention

The present invention relates to a lens and a method of manufacturing the same, and more particularly, to a lens having firm coupling between lens layers, and a method of manufacturing the same.

2. Description of the Related Art

Recently, a wide range of electronic devices, a cell phone for example, have been miniaturized and lightened, requiring components mounted therein to also be miniaturized and lightened.

Most recently produced portable phones have included a camera module. However, since phone camera modules include at least one lens, there are limitation in reducing the weight and a size thereof.

Therefore, a lens assembly provided in a camera module has been manufactured based on a wafer. Wafer-based lens assemblies have strengths that they are able to have a small size and to be thinned.

That is, since the wafer based lens assembly is manufactured without a separate assembly process, unlike a general injection lens, productivity in lens assembly is excellent, and a production cost thereof is cheap.

The wafer base lens is manufactured by stacking a plurality of wafers. Here, each of the wafers has a predetermined lens surface and is adhered to (or stacked on) another wafer to configure a lens surface having a new feature.

Meanwhile, since the wafer is a significantly thin and wide member, when two sheets of wafers are compressed, they may be easily deformed due to the pressure of expanding air. The deformation of the wafers is directly associated with the quality of the lens to be manufactured. Therefore, a method capable of preventing deformation of a lens surface due to the pressure of expanding air, at the time of the adhesion (or stacking) of wafers has been demanded.

### SUMMARY OF THE INVENTION

An aspect of the present invention provides a lens having significantly reducing deformation of a surface thereof caused by the pressure of expanding air generated at the time of adhesion (or stacking) of thin lens members such as wafers, and a method of manufacturing the same.

According an aspect of the present invention, there is provided a lens including: a first lens member having a lens surface formed thereon; a second lens member having a lens surface formed thereon; and an adhesive member adhering the first and second lens members to each other, wherein the first and second lens members include a ventilation path formed therebetween in order to discharge air therethrough.

The ventilation path may be formed on the first lens member or the second lens member.

The ventilation path may be extended from the lens surface to the outside.

According to another aspect of the present invention, there is provided a method of manufacturing a lens, the method including: preparing a plurality of lens members, each having a lens surface formed thereon; forming an adhesive layer on at least one of the lens members to allow for the adhesion thereof and forming a ventilation path in the adhesive layer; and stacking and adhering the plurality of lens members.

According to another aspect of the present invention, there is provided a method of manufacturing a lens, the method including: preparing a lens member having a lens surface and a ventilation path formed therein; forming an adhesive layer on the lens member; and stacking and adhering another lens member on the lens member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a lens according to an embodiment of the present invention;

FIG. 2 is a plan view of the lens shown in FIG. 1;

FIGS. 3 and 4 are plan views showing a modified example of the lens according to the embodiment of the present invention;

FIG. 5 is a cross-sectional view showing another modified example of the lens according to the embodiment of the present invention;

FIGS. 6A through 6D are views showing an example of a method of manufacturing a lens according to the embodiment of the present invention; and

FIGS. 7A through 7C are views showing another example of a method of manufacturing a lens according to the embodiment of the present invention.

### DETAILED DESCRIPTION OF THE INVENTION

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

Hereinafter, embodiments of the present invention will be described in detail with reference to the accompanying drawings.

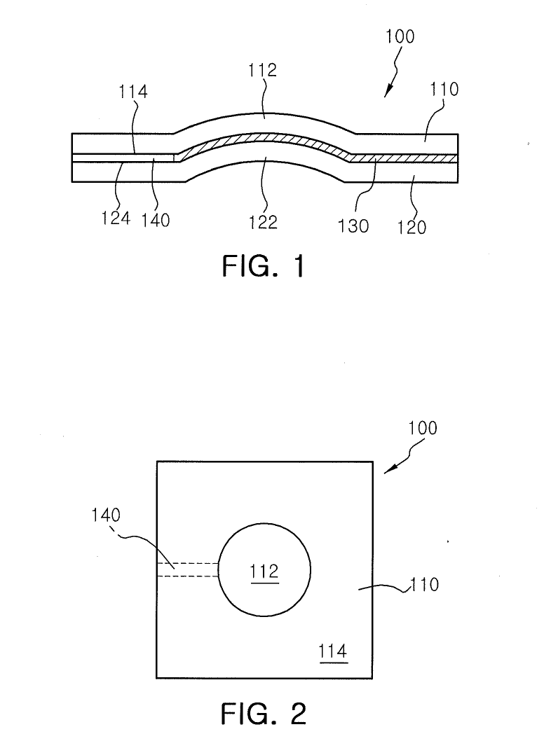

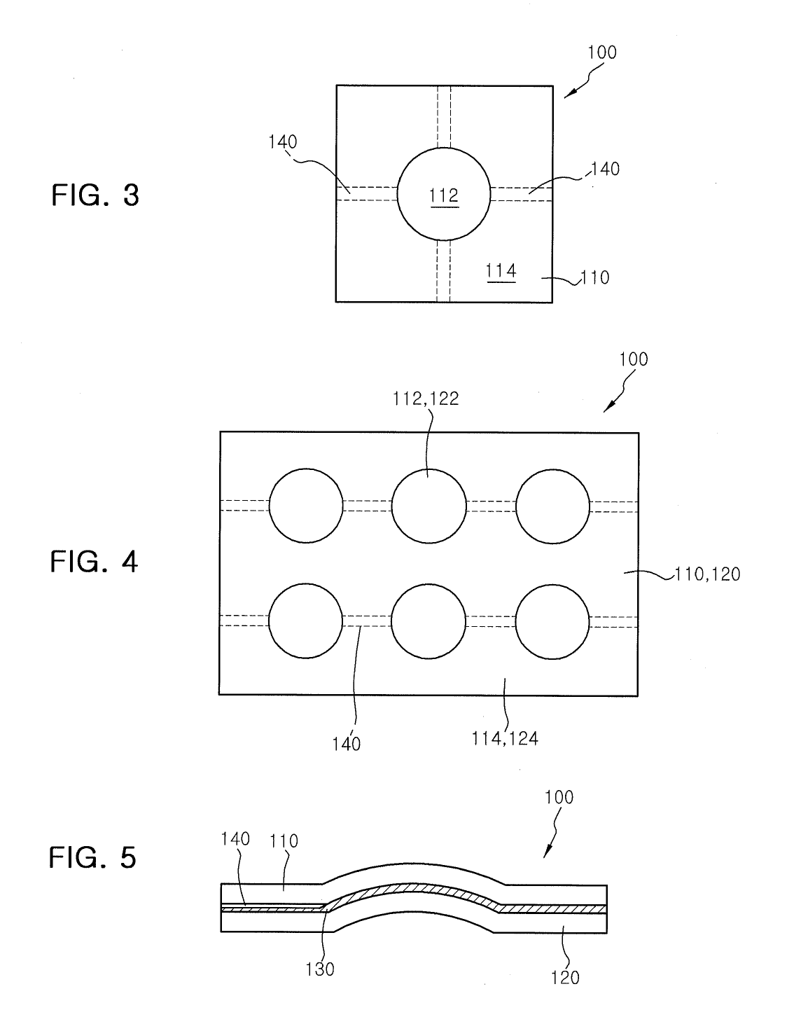

FIG. 1 is a cross-sectional view of a lens according to an embodiment of the present invention; FIG. 2 is a plan view of the lens shown in FIG. 1; FIGS. 3 and 4 are plan views showing a modified example of the lens according to the embodiment of the present invention; and FIG. 5 is a cross-sectional view showing another modified example of the lens according to the embodiment of the present invention.

An embodiment of the present invention will be described with reference to FIGS. 1 and 2.

The lens 100 according to the present embodiment includes a first lens member 110 and a second lens member 120.

The first lens member 110 may include a first optical part 112 and a first bonding part 114. The first optical part 112 is a part forming a lens surface in the first lens member 110. The first optical part 112 has a convex cross section as shown in FIG. 1. However, a shape of the first optical part 112 shown in FIG. 1 is only an example and may be changed according to a use and a function of the lens 100. Therefore, the lens surface formed by the first optical part 112 may be a spherical surface, an aspherical surface, or a plane. The first bonding part 114 is a part at which the lens members are adhered to each other. Therefore, the first bonding part 114 may be a plane shape so that different lens members may relatively more smoothly contact each other.

The second lens member 120 may include a second optical part 122 and a second bonding part 124. The second optical part 122 is a part forming a lens surface in the second lens member 120. The second optical part 122 may have a convex cross section overlapped with the first optical part 112. However, a shape of the second optical part 122 shown in FIG. 1 is only an example and may be different from that of the first optical part 112 according to a use and a function of the lens 100. For reference, the lens surface formed by the second optical part 122 may be a spherical surface, an aspherical surface, or a plane. The second bonding part 124 is a part at which the second lens member 120 is adhered to another lens member. According to the present embodiment, the second bonding part 124 surface-contacts the first bonding part 114 of the first lens member 110.

An adhesive member 130 may be applied or coated between the first and second lens members 110 and 120. The adhesive member 130 may be applied to the first and second lens members 110 and 120 to thereby adhere the first and second lens members 110 and 120 to each other. The adhesive member 130 may be a general adhesive. In some cases, the adhesive member 130 may be a photocurable resin cured by ultraviolet rays, or the like.

Meanwhile, although FIG. 1 shows that the adhesive member 130 is applied to all of the bonding parts 114 and 124 and the optical parts 112 and 122, the adhesive member 130 may also not be applied to the optical parts 112 and 122 according to a use and a function of the manufactured lens 100.

A ventilation path 140 may be formed in the adhesive member 130. The ventilation path 140 may start from the optical parts 112 and 122, pass through the bonding parts 114 and 124, and may be then completely opened outside the first and second lens members 110 and 120. The ventilation path 140 formed as described above may remove expansion pressure of air generated between the first and second optical parts 112 and 122 at the time of adhesion between the first and second lens members 110 and 120. That is, air present between the optical parts 112 and 122 may be discharged to the outside through the ventilation path 140.

Therefore, according to the present embodiment, deformation of the optical parts 112 and 122 caused by the expansion pressure that has been often generated during a adhesion process between the lens members 110 and 120 is not generated, such that a lens having excellent quality may be obtained.

For reference, although FIG. 1 shows a case in which two lens members 110 and 120 are stacked, at least three lens members may be stacked according to a use and a function of the lens. In this case, the ventilation path 140 may be formed on every adhesion surface at which the lens members are adhered to each other.

Hereinafter, modified examples of the present embodiment will be described.

First, a first modified example of the embodiment will be described with reference to FIGS. 3 and 4.

The lens 100 according to the present modified example has a plurality of ventilation paths 140 as shown in FIG. 3. According to the present modified embodiment, four ventilation paths 140 may be formed on the bonding part 114. The plurality of ventilation paths 140 may be disposed based on the optical part 112 to thereby rapidly and effectively remove the expansion pressure generated from the optical part 112 (that is, may rapidly discharge the air between the optical parts 112 and 114 to the outside).

Therefore, in the lens 100 according to the present modified example, the expansion pressure generated from the optical part 112 may be effectively removed even in the case in which an area of the optical part 112 is relatively large.

Meanwhile, when a plurality of optical parts 112 and 122 are formed in the lens members 110 and 120 as shown in FIG. 4, the optical parts 112 and 122 positioned at edges of the lens members 110 and 120 may include ventilation paths 140 that are in communication with the outside of the lens members 110 and 120. However, the optical parts 112 and 122 positioned at an inner side of the lens members 110 and 120 are difficult to include ventilation paths 140 that are indirect communication with the outside of the lens members 110 and 120.

Therefore, when the plurality of optical parts 112 and 122 are formed in the lens members 110 and 120, the ventilation paths 140 may be formed in a form in which they connect between the optical parts 112 and 122 to each other.

Next, another modified example of the embodiment will be described with reference to FIG. 5.

The lens 100 according to the present embodiment is different in a formation position of the ventilation path 140 from the above-mentioned lenses. That is, according to the present modified example, the ventilation path 140 may be formed on the first lens member 110 or the second lens member 120 (for reference, according to the present modified embodiment, the ventilation path 140 is formed on the first lens member 110).

The ventilation path 140 on the lens members 110 and 120 may be formed by processing completed lens members 110 and 120 or changing a mold for a lens member. In the lens 100 having this structure, since the ventilation path 140 needs not to be formed in the adhesive member 130, which is in a liquid state, the ventilation path 140 may be more easily formed.

Hereinafter, a method of manufacturing the lens 100 having the above-mentioned structure will be described. For reference, the components described in the above-mentioned embodiment will be denoted by the same reference numerals and a description thereof will be omitted.

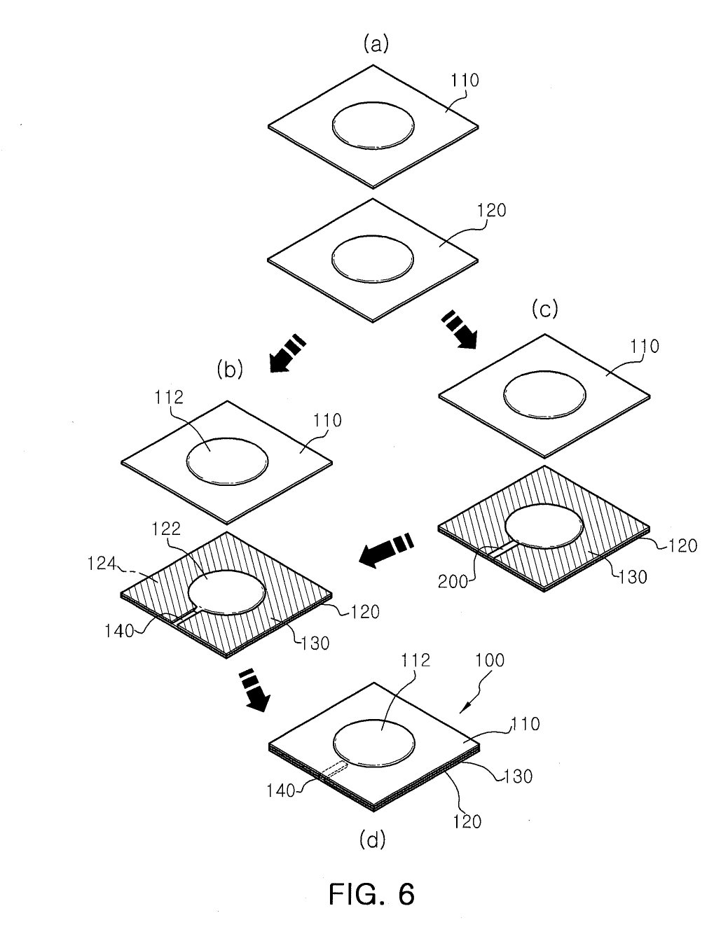

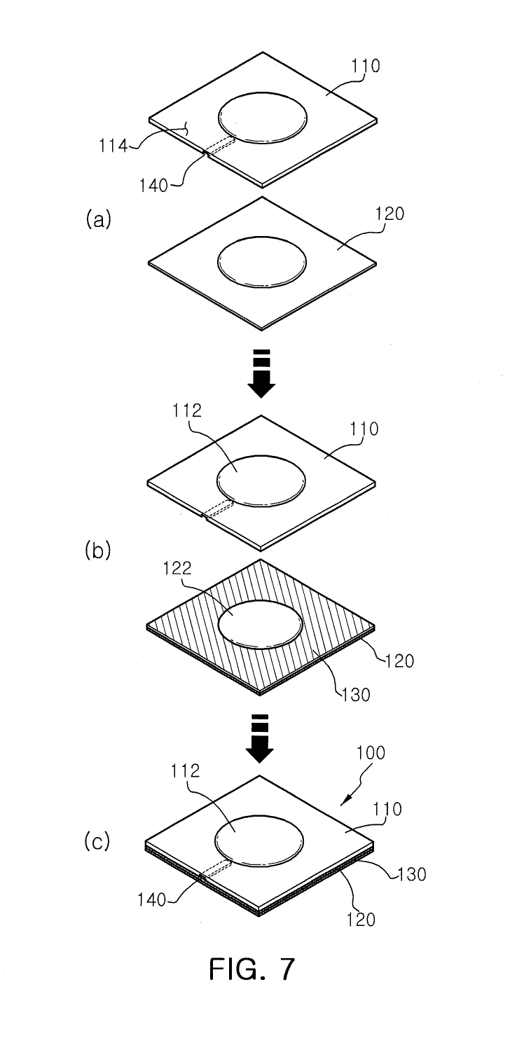

Hereinafter, a method of manufacturing a lens according to the embodiment of the present invention will be described with reference to FIGS. 6 and 7. FIGS. 6A to 6D are views showing an example of a method of manufacturing a lens according to the embodiment of the present invention.

In order to manufacture the lens 100 according to the above-mentioned embodiment, a first lens member 110 and a second lens member 120 may be prepared. Then, in order to adhere the two lens members to each other, an adhesive member 130 may be applied to one surface of the first or second lens member 110 or 120. The adhesive member 130 may be applied to the second bonding part 124 except for a second optical part 122. However, the adhesive member 130 may also be applied to the second optical part 122 as needed.

Here, as a method of applying the adhesive member 130, there may be two methods. One method is to apply the adhesive member 130 on a portion except a portion that will become a ventilation path 140 as shown in FIG. 6B, and another method is to apply the adhesive member 130 in a state in which a separate temporal member 200 is placed on the portion that will become the ventilation path 140 as shown in FIG. 6C.

According to the former method, after the application of the adhesive member 130 is finished, the first and second lens members 110 and 120 may be adhered to each other to thereby complete the lens. Therefore, in the case of the former method, a process of manufacturing a lens may be simple.

On the other hand, according to the latter method, after the application of the adhesive member 130 is finished, a process of removing the temporal member 200 needs to be additionally performed in order to form the ventilation path 140. However, in the case of the latter method, since a formation position and a shape of the ventilation path 140 are certainly ensured, an effect of removing the expansion pressure by the ventilation path 140 may be more excellent as compared to the former method.

When the adhesion between the first and second lens members 110 and 120 is finished through the above-mentioned process, the lens 100 including the ventilation path 140 shown in FIG. 6D is completed. As described above, the ventilation path 140 of the lens 100 may remove the expansion pressure between the optical parts 112 and 122 at the time of adhesion between the first and second lens members 110 and 120, thereby improving quality of the completed lens 100.

FIGS. 7A through 7C are views showing another example of a method of manufacturing a lens according to the embodiment of the present invention. The method of manufacturing a lens according to the present embodiment will be described below.

First, first and second lens members 110 and 120 may be prepared. Here, at least one of the lens members 110 and 120 may have a ventilation path 140. The ventilation path 140 may be formed after the lens members 110 and 120 are completed as described above or be formed during a process of forming the lens member 110 and 120.

Then, an adhesive member 130 may be applied to one surface (adhesion surface) of the first or second lens member 110 or 120. The adhesive member 130 may be applied to a lens member on which the ventilation path 140 is not formed, if possible. This is to prevent the ventilation path 140 from being blocked or a flow channel of the ventilation path 140 from becoming narrow due to the adhesive member 130.

After the application of the adhesive member 130 is finished, the first and second lens members 110 and 120 are adhered to each other. Air compressed by the optical parts 112 and 122 at the time of the adhesion between the lens members 110 and 120 may be discharged through the ventilation path 140. Then, when the adhesion between the first and second lens members 110 and 120 is finished, the lens 100 is completed.

Meanwhile, since the ventilation path 140 is no longer required after the lens 100 is completed, the ventilation path 140 may be closed or a predetermined fluid may be injected through the ventilation path 140 to change lens characteristics by the optical parts 112 and 122.

As set forth above, according to the embodiments of the present invention, deformation of the lens member caused by expansion pressure of air generated at the time of stacking of the lens members may be significantly reduced. Therefore, according to the embodiments of the present invention, a defective rate of the lens generated during a process of producing a lens member may be reduced, and quality of the lens member may be improved.

While the present invention has been shown and described in connection with the embodiments, it will be apparent to those skilled in the art that modifications and variations can be made without departing from the spirit and scope of the invention as defined by the appended claims.

What is claimed is:

1. A lens comprising:
a first lens member having a lens surface formed thereon;
a second lens member having a lens surface formed thereon; and
an adhesive member adhering the first and second lens members to each other,
the first and second lens members including a ventilation path formed therebetween in order to discharge air therethrough.

2. The lens of claim 1, wherein the ventilation path is formed on the first lens member or the second lens member.

3. The lens of claim 1, wherein the ventilation path is extended from the lens surface to the outside.

4. A method of manufacturing a lens, the method comprising:
preparing a plurality of lens members, each having a lens surface formed thereon;
forming an adhesive layer on at least one of the lens members to allow for the adhesion thereof and forming a ventilation path in the adhesive layer; and
stacking and adhering the plurality of lens members.

5. A method of manufacturing a lens, the method comprising:
preparing a lens member having a lens surface and a ventilation path formed therein;
forming an adhesive layer on the lens member; and
stacking and adhering another lens member on the lens member.
